(19) United States
(12) Patent Application Publication
(10) Pub. No.: US 2025/0225977 A1
(43) Pub. Date: Jul. 10, 2025

(54) SPEECH RECOGNITION METHOD, SPEECH RECOGNITION DEVICE, AND SPEECHRECOGNITION PROGRAM

(71) Applicant: NIPPON TELEGRAPH AND TELEPHONE CORPORATION, Tokyo (JP)

(72) Inventors: Atsunori OGAWA, Tokyo (JP); Taichi ASAMI, Tokyo (JP); Naohiro TAWARA, Tokyo (JP); Marc DELCROIX, Tokyo (JP); Shoko ARAKI, Tokyo (JP)

(73) Assignee: NIPPON TELEGRAPH AND TELEPHONE CORPORATION, Tokyo (JP)

(21) Appl. No.: 18/847,830

(22) PCT Filed: Mar. 23, 2022
(86) PCT No.: PCT/JP2022/013754

§ 371 Date: Sep. 17, 2024

(51) Int. Cl. G10L 15/01; G10L 15/16; G10L 15/183

(52) U.S. Cl. CPC G10L 15/01; G10L 15/16; G10L 15/183

(57) ABSTRACT

A voice recognition device (10) according to an embodiment includes a voice recognition unit (131) and a score calculation unit (132). The voice recognition unit (131) generates a lattice based on a result of voice recognition of speech. The score calculation unit (132) updates a score of the lattice based on an output of an NLM corresponding to each type of processing and a coefficient which is based on the number of repetitions or performance of the NLM during execution of each type of processing in each type of processing repeatedly executed a predetermined number of times (repeated lattice rescoring).

### TECHNICAL FIELD

The present invention relates to a voice recognition method, a voice recognition device, and a voice recognition program.

### BACKGROUND ART

Voice recognition is a technology of converting a voice (speech) spoken by a person into a word string (text) by a computer.

In general, a voice recognition system outputs one word string (one-best hypothesis) which is a hypothesis (voice recognition result) with a highest voice recognition score for one input speech.

In response, accuracy of voice recognition processing by a voice recognition device is not 100%. On the other hand, in the related art, a scheme called lattice rescoring is known as a scheme for improving accuracy of voice recognition processing (see, for example, NPL 1).

In lattice rescoring, a lattice efficiently expressing a plurality of voice recognition hypotheses is output instead of outputting one best hypothesis for one input utterance. As postprocessing, a hypothesis estimated as an Oracle hypothesis (the hypothesis having the highest accuracy and the hypothesis having the lowest errors) is selected from lattices using a certain model. The Oracle hypothesis may also be referred to as a one best hypothesis.

In the lattice rescoring, a scheme using a language model based on a neural network (neural language model (NLM)) is known (see, for example, NPL 2 and NPL 3).

### CITATION LIST

### Non Patent Literature

[NPL 1]M. Auli, M. Galley, C. Quirk, and G. Zweig, “Joint language and translation modeling with recurrent neural networks,” in Proc. EMNLP, 2013, pp. 1044 to 1054.
[NPL 2]S. Kumar, M. Nirschl, D. Holtmann-Rice, H. Liao, A. T. Suresh, and F. Yu, “Lattice rescoring strategies for long short term memory language models in speech recognition,” in Proc. ASRU, 2017, pp. 165 to 172.
[NPL 3]K. Irie, A. Zeyer, R. Schlüter, and H. Ney, “Language modeling with deep Transformers,” in Proc. Interspeech, 2019, pp. 3905 to 3909.
[NPL 4]W. Xiong, L. Wu, F. Alleva, J. Droppo, X. Huang, and A. Stolke, “The Microsoft 2017 conversational speech recognition system,” in Proc. ICASSP, 2018, pp. 5934 to 5938.

### SUMMARY OF INVENTION

### Technical Problem

However, the technologies of the related art have the problem that voice recognition may not be performed with high accuracy by lattice rescoring.

For example, NPL 4 discloses a scheme in which a plurality of NLMs are caused to calculate scores in the lattice rescoring.

On the other hand, it has not been sufficiently examined how to weight each of the scores calculated by the plurality of NLMs.

### Solution to Problem

In order to solve the above-described problems and achieve an object, a voice recognition method executed by a computer includes: a generation procedure of generating a lattice based on a result of voice recognition of speech; and a score calculation procedure of updating a score of the lattice based on an output of an NLM corresponding to each type of processing and a coefficient which is based on the number of repetitions or performance of the NLM during execution of each type of processing in each type of processing repeatedly executed a predetermined number of times.

### Advantageous Effects of Invention

According to the present invention, voice recognition by lattice rescoring can be performed with high accuracy.

### BRIEF DESCRIPTION OF DRAWINGS

FIG. 1 is a diagram illustrating a configuration example of a voice recognition device according to an embodiment.

FIG. 2 is a diagram illustrating lattices.

FIG. 3 is a diagram illustrating an acoustic score and a language score.

FIG. 4 is a diagram illustrating updating of a language score.

FIG. 5 is a diagram illustrating updating of a language score by an i-th NLM.

FIG. 6 is a flowchart illustrating a flow of processing of the voice recognition device of the embodiment.

FIG. 7 is a flowchart illustrating the flow of rescoring processing.

FIG. 8 is a diagram illustrating experimental results.

FIG. 9 is a diagram illustrating an example of a computer that executes a voice recognition program.

### DESCRIPTION OF EMBODIMENTS

Hereinafter, embodiments of a voice recognition method, a voice recognition device, and a voice recognition program according to the present application will be described in detail with reference to the drawings. The present invention is not limited to the embodiments to be described below.

### Configuration of First Embodiment

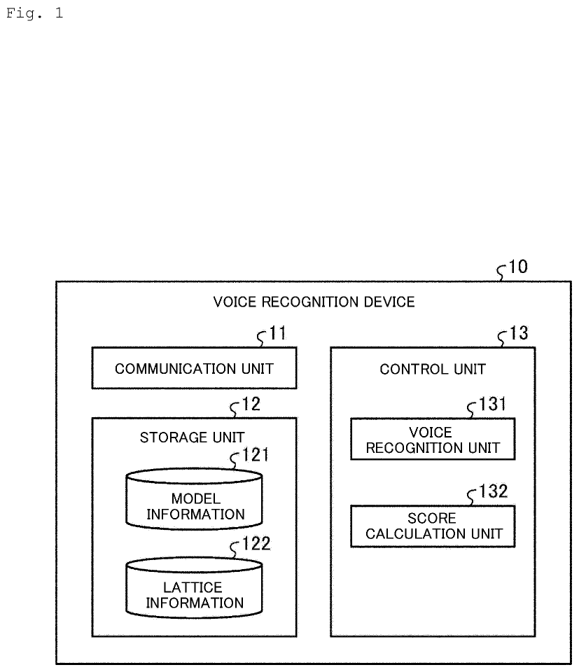

First, a configuration of a voice recognition device according to a first embodiment will be described with reference to FIG. 1. FIG. 1 is a diagram illustrating an example of a configuration of a voice recognition device according to a first embodiment. A voice recognition device 10 receives an input of voice data, performs voice recognition, and outputs a word string as a voice recognition result.

As illustrated in FIG. 1, the voice recognition device 10 includes a communication unit 11, a storage unit 12, and a control unit 13.

The communication unit 11 performs data communication with another device via a network. The communication unit 11 is, for example, a network interface card (NIC).

The storage unit 12 is a storage device such as a hard disk drive (HDD), a solid state drive (SSD), or an optical disc. The storage unit 12 may be a semiconductor memory in which data is rewriteable, such as a random access memory (RAM), a flash memory, or a nonvolatile static random access memory (NVSRAM). The storage unit 12 stores an operating system (OS) or various programs which are executed by the voice recognition device 10.

The storage unit 12 stores model information 121 and lattice information 122.

The model information 121 is information such as parameters and the like for constructing each of a plurality of NLMs.

The lattice information 122 is information regarding lattices. The lattice information 122 includes nodes, arcs, and scores. The details of the lattices will be described below.

The control unit 13 controls the voice recognition device 10. The control unit 13 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA).

The control unit 13 includes an internal memory that stores a program or control data that defines various processing procedures, and performs each processing using the internal memory.

The control unit 13 functions as any of various processing units by operating various programs. The control unit 13 includes, for example, a voice recognition unit 131 and a score calculation unit 132.

The voice recognition unit 131 performs voice recognition on speech. The voice recognition unit 131 generates lattices based on a result of voice recognition of the speech. The voice recognition unit 131 stores the generated lattices as lattice information 122 in the storage unit 12.

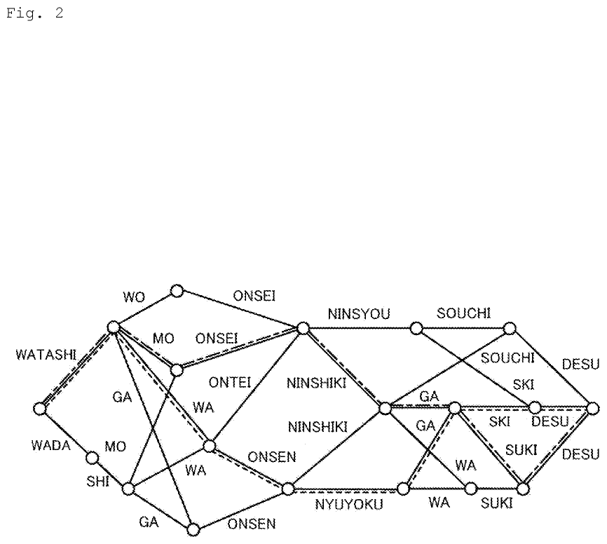

Here, the latices will be described with reference to FIG. 2. FIG. 2 is a diagram illustrating the lattices.

As illustrated in FIG. 2, the lattices include nodes and arcs. A node represents a word boundary of a recognition result word (word obtained through voice recognition). An arc is a recognition result word itself.

The lattices illustrated in FIG. 2 are generated based on the speech “WATASHI WA ONSEI NINSHIKI GA SKI DESU.”

At this time, a one-best hypothesis is “WATASHI WA ONSEN NYUYOKU GA SUKI DESU” (dotted line in FIG. 2). The Oracle hypothesis is “WATASHI MO ONSEI NINSHIKI GA SUKI DESU” (the dashed line in FIG. 2).

In this way, a plurality of word strings are extracted from the lattices. The extracted word string includes the one-best hypothesis and the Oracle hypothesis. The one-best hypothesis may be the Oracle hypothesis.

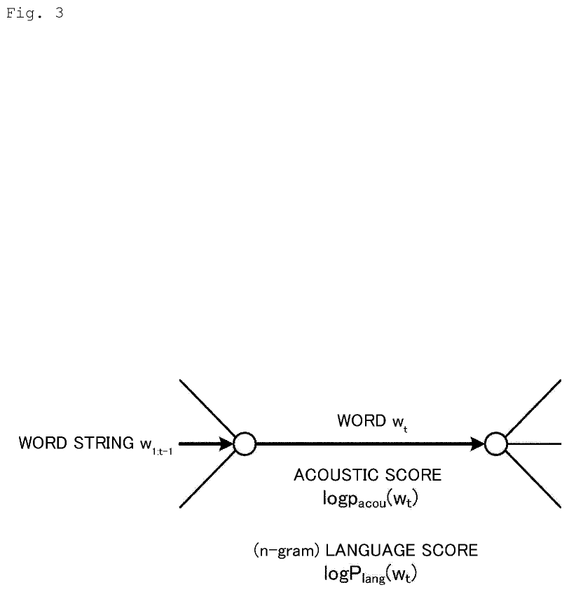

FIG. 3 is a diagram illustrating an acoustic score and a language score. As illustrated in FIG. 3, an acoustic score (logarithmic likelihood) and a language score (logarithmic probability) calculated through voice recognition processing are each assigned to the arc.

The acoustic score is an estimated value indicating how acoustically correct a recognition result word is. The language score is an estimated value indicating how verbally correct a recognition result word is.

The voice recognition unit 131 can calculate a language score using an n-gram language model (where n is usually about 3 to 5) expressing an n-chain probability of the word. The voice recognition unit 131 can calculate an acoustic score by a neural network for voice recognition in which a voice signal is accepted as an input.

It is assumed that information for constructing the n-gram language model and the neural network for voice recognition is stored as model information 121 in the storage unit 12.

The score calculation unit 132 performs lattice rescoring. Lattice rescoring is performed using a rescoring model as postprocessing of voice recognition processing.

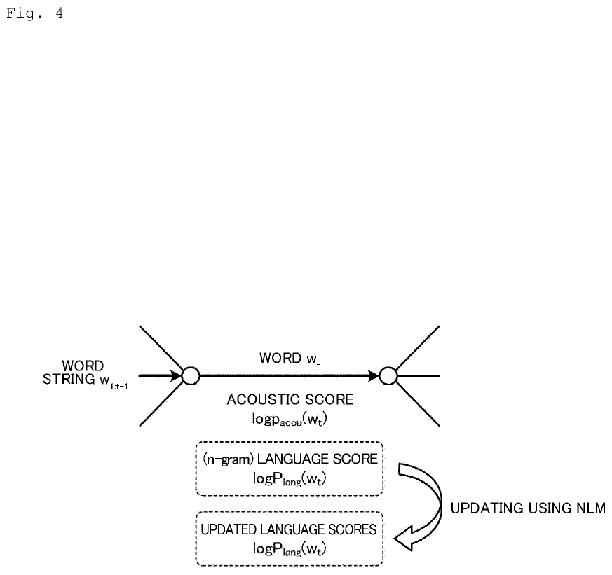

According to the lattice rescoring, as illustrated in FIG. 4, it is possible to assign a language score with higher accuracy to an arc (recognition result word) than the language score assigned by the n-gram language model. FIG. 4 is a diagram illustrating updating of the language score. In the example of FIG. 4, the language score is updated using an NLM.

In recent years, an NLM which can ascertain a context longer than that of the n-gram language model and can predict words with higher accuracy has been used as a rescoring model. The high word prediction accuracy means that a word to be generated subsequently when a history of words is given can be predicted with high accuracy.

The lattice rescoring using an NLM are disclosed in, for example, in NPL 2, NPL 3, and NPL 4.

NPL 1 discloses, as a scheme of the lattice rescoring based on a push-forward algorithm, a scheme of performing search (hypothesis development) on lattices from a starting node to an ending node by using an NLM and updating a language score recorded in an arc.

In the scheme described in NPL 1, of hypotheses (word strings) reaching the ending node, a hypothesis with a highest score (weighted addition score of an acoustic score and an updated language score) is defined as a final voice recognition result.

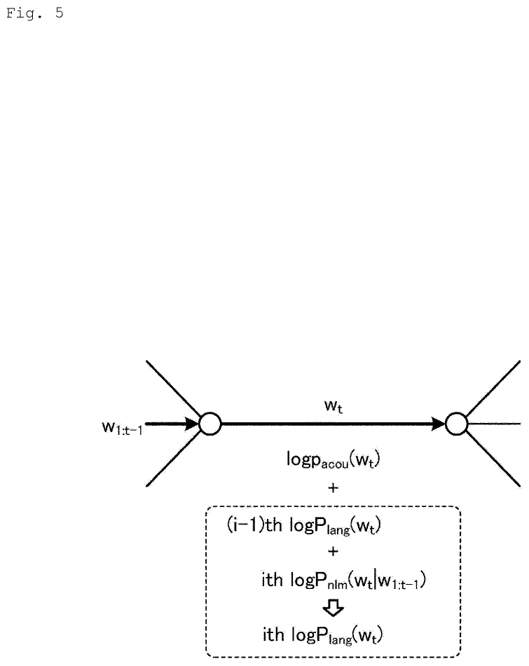

Here, the repeated lattice rescoring by the score calculation unit 132 will be described focusing on search processing in a certain arc on the lattice as illustrated in FIG. 5.

w_{1:t-1} is a hypothesis of length t−1. It is assumed that a current score (logarithmic likelihood) of the hypothesis w_{1:t-1} is log p(w_{1:t-1}), and that an arc (recognition result word) wₜ having an acoustic score (logarithmic likelihood) log p_{acou}(wₜ) and a language score (logarithmic probability) log P_{lang}(wₜ) is reached.

The score calculation unit 132 calculates a score of the hypothesis w_{1:t} of the length t as shown by Formula (1) by developing the hypothesis w_{1:t-1} on the arc wₜ.

$$\begin{matrix}[ Math . 1 ] & \\ & ( 1 )\end{matrix}$$

$$log p ( {w}_{1 : t} ) log p ( {w}_{1 : t - 1} ) + log {p}_{acou} ( {w}_{t} ) + α \{ ( 1 - β ) log {P}_{lang} ( {w}_{t} ) + β log {P}_{resc} ( {w}_{t} \vert {w}_{1 : t - 1} ) \}$$

Here, log p_{resc}(wₜ|w_{1:t-1}) is a language score of wₜ when w_{1:t-1} is given, and is calculated by the NLM for rescoring. β (0<β<1) is an interpolation coefficient of the original language score and the language score calculated by the NLM for rescoring. α (α>0) is a weight of the language score to the acoustic score.

The underlined term of Formula (1) corresponds to the updated language score. The score calculation unit 132 obtains the lattices in which the language score is updated by performing the search processing (score calculation for each reached arc) described here for all the arcs on the lattices.

When a plurality of NLMs are used, the score calculation unit 132 repeats the search processing (repeated lattice rescoring). Then, whenever the score calculation unit 132 repeats the search processing, a language score (logarithmic probability) log P_{lang}wₜ is gradually updated (accuracy is improved).

In this case, it is not obvious how β is set. If the number of NLMs to be used is at most several, it is also possible to set β heuristically (manually). However, when more NLMs is used, it is necessary to design how β is set for each repetition number (i in FIG. 5). Hereinafter, a method in which the score calculation unit 132 sets the interpolation coefficient β will be described below.

### (β Setting Method 1)

The number of repetitions (language score updating) of the repeated lattice rescoring is defined as I. That is, the number of NLMs used for repeated lattice rescoring is I. When it is assumed that the word prediction accuracy of I NLM is approximately the same, it is sufficient that a language score output by I NLM is equally evaluated (weighted) when the I repetition is completed. Therefore, the score calculation unit 132 sets β in i-th repetition as shown in Formula (2).

$$\begin{matrix}[ Math . 2 ] & \\ β ( i ) = \frac{1}{1 + i} & ( 2 )\end{matrix}$$

In this way, the score calculation unit 132 sets a value which decreases smaller as the number of repetitions increases as a coefficient.

### (β Setting Method 2)

When a nature of voice data used for voice recognition by the voice recognition unit 131 is clear and text data having the same nature as the voice data can be obtained, the score calculation unit 132 can set β using word prediction accuracy for the text data of each NLM.

At this time, perplexity can be used as a scale of word prediction accuracy. When PPL (i) is perplexity of the NLM used in the i-th repetition for the text data, the score calculation unit 132 sets β in the i-th repetition as shown by Formula (3).

$$\begin{matrix}[ Math . 3 ] & \\ β ( i ) = \frac{1}{1 + PPL ( i ) {\sum }_{j = 0}^{i - 1} \frac{1}{PPL ( j )}} & ( 3 )\end{matrix}$$

Here, PPL (0) is the perplexity of the n-gram language model for the text data. The above-described repeated lattice rescoring can also be applied to an N best list which is a special shape of lattices (repeated N best rescoring).

In this way, the score calculation unit 132 sets, as the coefficient β, a value of the NLM corresponding to each process, the value increasing as the word prediction accuracy for text data with the same nature as a recognition target speech is higher.

The perplexity is an example of an index representing the performance of the NLM. PPL (i) decreases as the word estimation accuracy of the NLM is higher.

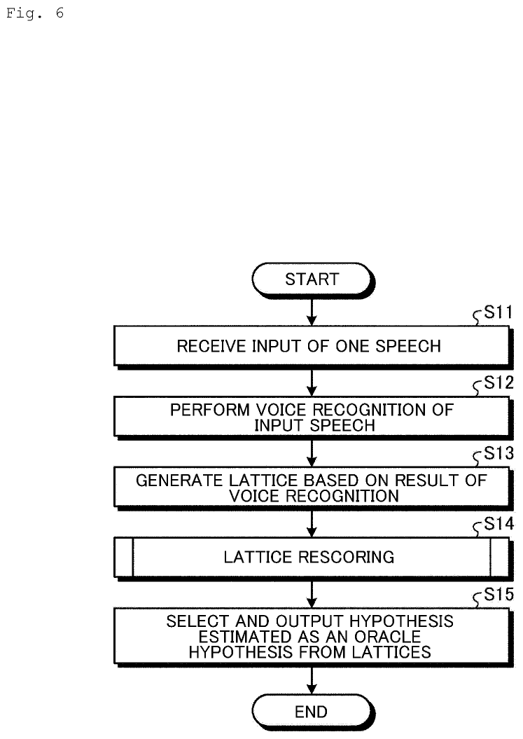

FIG. 6 is a flowchart illustrating a flow of processing of the voice recognition device according to the embodiment. As illustrated in FIG. 6, the voice recognition device 10 first receives an input of one speech (step S11). The speech is, for example, voice data representing a voice signal in a predetermined format.

Subsequently, the voice recognition device 10 performs voice recognition of the input speech (step S12). Then, the voice recognition device 10 generates lattices based on a result of the voice recognition (step S13).

Here, the voice recognition device 10 performs the lattice rescoring (step S14). Then, the voice recognition device 10 selects and outputs a hypothesis estimated as the Oracle hypothesis from the lattices of which the scores are updated by the lattice rescoring (step S15). For example, the voice recognition device 10 outputs a word string based on the selected hypothesis.

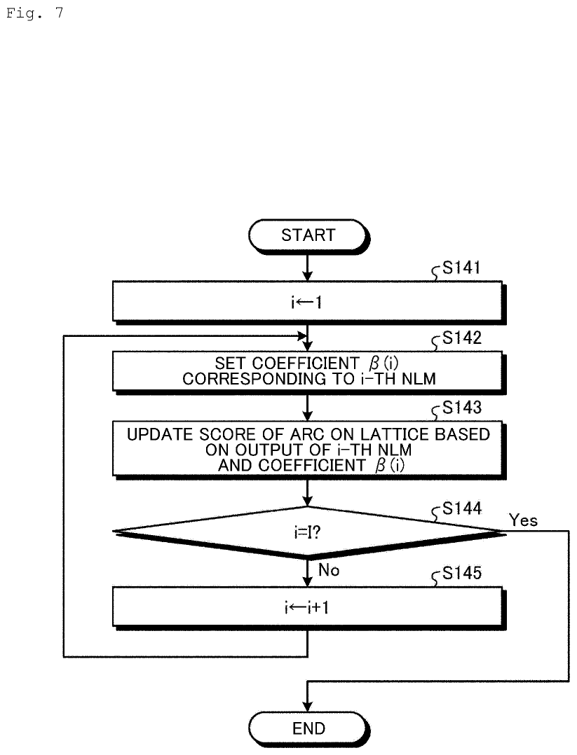

FIG. 7 is a flowchart illustrating a flow of lattice rescoring processing. The processing of FIG. 7 corresponds to the processing of step S14 of FIG. 6.

As illustrated in FIG. 7, the voice recognition device 10 sets i to 1 (step S141). i is an index for identifying a model (for example, an NLM) for calculating a score. In addition, i can be referred to as the current number of repetitions of the lattice rescoring.

Information for constructing a plurality of models for calculating the score is included in the model information 121.

Here, the voice recognition device 10 sets a coefficient β(i) corresponding to an i-th NLM (step S142). For example, the voice recognition device 10 calculates the coefficient β(i) by the β setting method 1 or the β setting method 2.

Then, the voice recognition device 10 updates the score of the arc on the lattice based on the output of the i-th NLM and the coefficient β(i) (step S143).

When i is not I (No in step S144), the voice recognition device 10 increases i by 1 (step S145), the processing is returned to step S142 to repeat the processing.

Conversely, when i is I (Yes in step S144), the voice recognition device 10 ends the processing. I is a total number of repetitions of the lattice rescoring and is the number of used NLMs.

In this way, the score calculation unit 132 updates scores of lattices, in each of processing repeatedly perform a predetermined number of times (for example, I times), an output of the NLM corresponding to each type of processing and the coefficient (β) which is based on the number of repetitions (for example, i) or the performance of the NLM in the execution of each type of processing.

### Advantageous Effects of First Embodiment

As described above, the voice recognition unit 131 generates lattices based on a voice recognition result of speech. The score calculation unit 132 updates scores of lattices, in each of type of processing repeatedly perform a predetermined number of times, an output of the NLM corresponding to each type of processing and the coefficient which is based on the number of repetitions or the performance of the NLM in the execution of each type of processing.

Accordingly, it is possible to perform weighting by a coefficient based on the number of repetitions or the performance of NLM, and perform voice recognition by the lattice rescoring with high accuracy.

The score calculation unit 132 sets a value decreasing as the number of repetitions increases as a coefficient. Accordingly, each NLM can be evaluated equally.

The score calculation unit 132 sets, as a coefficient β, a value of the NLM corresponding to each type processing, the value increasing as word prediction accuracy for text data with the same nature as a recognition target speech is higher. Accordingly, it is possible to reflect the word prediction accuracy of each NLM in the score of the lattice.

Here, the recognition target speech is speech on which voice recognition is performed by the voice recognition unit 131 and in which a recognition result (word string) of the speech is unknown. Conversely, if the nature of the recognition target speech is known, it is possible to calculate the perplexity in advance for text data with the same nature.

For example, when the recognition target speech is related to weather forecast, the score calculation unit 132 can calculate the perplexity of the NLM for text data related to the weather forecast, and set the coefficient β based on the calculated perplexity.

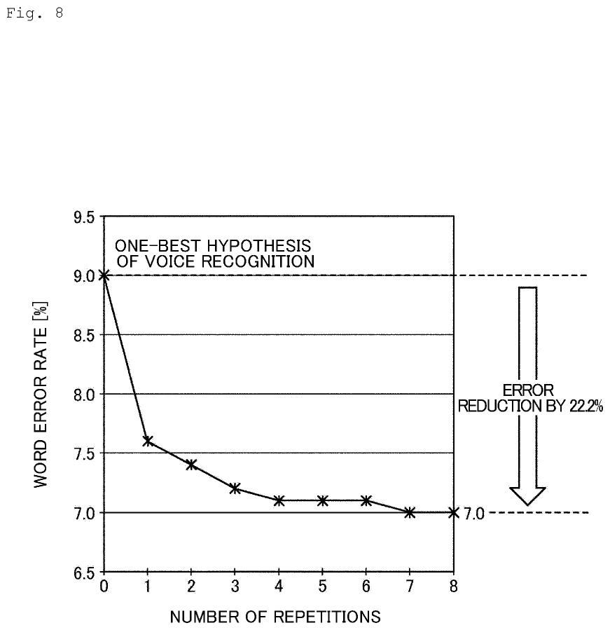

FIG. 8 illustrates the results obtained through repeated lattice rescoring using eight NLM based on Formula (1) and Formula (2) by the method described in the embodiment. FIG. 8 is a diagram illustrating experimental results.

It can be understood from FIG. 8 that a word error rate (the lower the word error rate is, the higher the accuracy is) can be gradually reduced whenever the scoring is repeated. Finally, the word error rate of the one-best hypothesis of the voice recognition processing is reduced from 9.0% to 7.0%.

### [System Configuration or the Like]

Each constituent of each of the illustrated devices is functionally conceptual, and does not necessarily need to be physically configured as illustrated. That is, specific forms of the distribution and integration of the devices are not limited to the illustrated forms. All or some of the forms of the distribution and integration of the devices can be distributed or integrated functionally or physically in any unit in accordance with various loads, usage situations, or the like. Further, all or some of the processing functions performed by the devices may be realized by a central processing unit (CPU) and a program that is analyzed and executed by the CPU, or may be realized as hardware using wired logic. The program may be executed not only by the CPU but also by another processor such as a GPU.

All or some of the types of processing described as being performed automatically among the types of processing described in the embodiments can be performed manually. Alternatively, all or some of the types of processing described as being performed manually can be performed automatically using a known method. In addition, information including the processing procedures, control procedures, specific names, and various types of data or parameters illustrated in the above literature or drawings can be arbitrarily changed unless otherwise mentioned.

### [Program]

According to an embodiment, the voice recognition device 10 can be implemented by installing a voice recognition program that executes the above-described voice recognition processing, as packaged software or online software, on a desired computer. For example, an information processing device can be caused to serve as the voice recognition device 10 by the information processing device executing the foregoing voice recognition program. The information processing device mentioned here includes desktop and laptop personal computers. In addition, information processing devices include a mobile communication terminal such as smartphone, mobile phone and personal handyphone system (PHS) and a slate terminal such as personal digital assistant (PDA).

The voice recognition device 10 may be implemented as a voice recognition server device which provides a service related to the voice recognition processing to a client which is a terminal device used by a user. For example, the voice recognition server device is implemented as a server device that provides a voice recognition service in which speech (voice data) is accepted as an input and a word string is output. In this case, the voice recognition server device may be implemented as a web server or as a cloud that provides services related to the foregoing voice recognition processing by outsourcing.

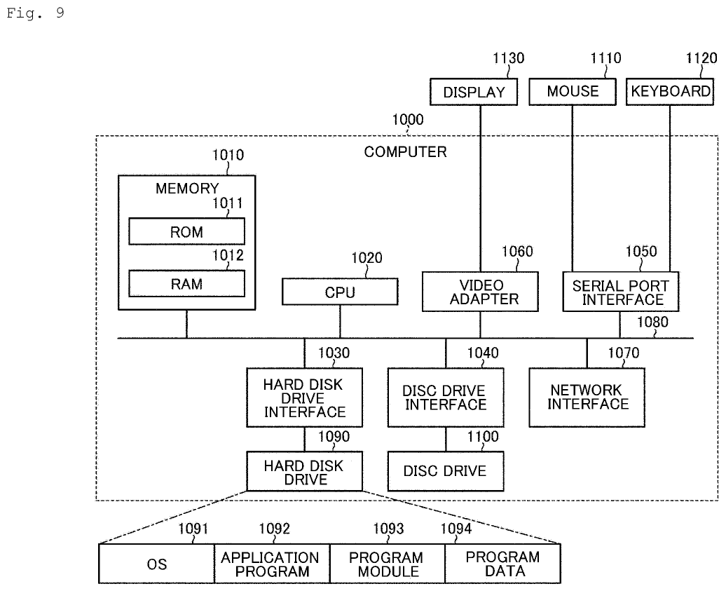

FIG. 9 is a diagram illustrating an example of a computer that executes a voice recognition program. A computer 1000 includes, for example, a memory 1010 and a CPU 1020. Further, the computer 1000 also includes a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program defining each type of processing by the voice recognition device 10 is implemented as the program module 1093 in which a code executable by the computer is described. The program module 1093 is stored in, for example, the hard disk drive 1090. For example, the program module 1093 that executes processing similar to the functional configuration of the voice recognition device 10 is stored in the hard disk drive 1090. The hard disk drive 1090 may be replaced with a solid state drive (SSD).

Setting data which is used in the processing of the above-described embodiment is stored as the program data 1094 in, for example, the memory 1010 or the hard disk drive 1090. The CPU 1020 reads the program module 1093 or the program data 1094 stored in the memory 1010 or the hard disk drive 1090 to the RAM 1012, as necessary, and executes the processing of the above-described embodiment.

The program module 1093 and the program data 1094 are not limited to being stored in the hard disk drive 1090, and may be stored in, for example, a detachable storage medium and read by the CPU 1020 via the disk drive 1100 or the like. Alternatively, the program module 1093 and the program data 1094 may be stored in another computer connected via a network (a local area network (LAN), a wide area network (WAN), or the like). Then, the program module 1093 and the program data 1094 may be read by the CPU 1020 from another computer via the network interface 1070.

### REFERENCE SIGNS LIST

10 Voice recognition device
11 Communication unit
12 Storage unit
13 Control unit
121 Model information
122 Lattice information
131 Voice recognition unit
132 Score calculation unit

1. A voice recognition method executed by a computer, the method comprising:
a generation procedure of generating a lattice based on a result of voice recognition of speech; and
a score calculation procedure of updating a score of the lattice based on an output of a Neural Language Model (NLM) corresponding to each type of processing and a coefficient which is based on the number of repetitions or performance of the NLM during execution of each type of processing in each type of processing repeatedly executed a predetermined number of times.

2. The voice recognition method according to claim 1, wherein, in the score calculation procedure, a value that decreases as the number of repetitions increases is set as the coefficient.

3. The voice recognition method according to claim 1, wherein, in the score calculation procedure, a value of an NLM corresponding to each type of processing is set as the coefficient, the value increasing as word prediction accuracy for text data with the same nature as the speech is higher.

4. A voice recognition device comprising:
a voice recognition unit configured to generate a lattice based on a result of voice recognition of speech; and
a score calculation unit configured to update a score of the lattice based on an output of a Neural Language Model (NLM) corresponding to each type of processing and a coefficient which is based on the number of repetitions or performance of the NLM during execution of each type of processing in each type of processing repeatedly executed a predetermined number of times.

5. (canceled)

6. The voice recognition device according to claim 4, wherein, in the score calculation procedure, a value that decreases as the number of repetitions increases is set as the coefficient.

7. The voice recognition device according to claim 4, wherein, in the score calculation procedure, a value of an NLM corresponding to each type of processing is set as the coefficient, the value increasing as word prediction accuracy for text data with the same nature as the speech is higher.

8. A computer-readable non-transitory recording medium storing computer-executable program instructions that when executed by a processor cause a computer to execute a voice recognition method comprising:
a generation procedure of generating a lattice based on a result of voice recognition of speech; and
a score calculation procedure of updating a score of the lattice based on an output of a Neural Language Model (NLM) corresponding to each type of processing and a coefficient which is based on the number of repetitions or performance of the NLM during execution of each type of processing in each type of processing repeatedly executed a predetermined number of times.

9. The computer-readable non-transitory recording medium according to claim 8 wherein the voice recognition method further comprises:
a value that decreases as the number of repetitions increases is set as the coefficient.

10. The computer-readable non-transitory recording medium according to claim 8 wherein the voice recognition method further comprises:
a value of an NLM corresponding to each type of processing is set as the coefficient, the value increasing as word prediction accuracy for text data with the same nature as the speech is higher.

11. The voice recognition method according to claim 1, wherein a weighting is carried out using the coefficient based on the number of repetitions or the performance of the NLM.

12. The voice recognition device according to claim 4, wherein a weighting is carried out using the coefficient based on the number of repetitions or the performance of the NLM.

13. The computer-readable non-transitory recording medium according to claim 8, wherein a weighting is carried out using the coefficient based on the number of repetitions or the performance of the NLM.
